(19) United States
(12) Patent Application Publication
(10) Pub. No.: US 2007/0147496 A1
(43) Pub. Date: Jun. 28, 2007

(54) Hardware implementation of programmable controls for inverse quantizing with a plurality of standards

(76) Inventors: Bhaskar Sherigar, Bangalore (IN); Anand Tongle, Nagpur (IN)

Correspondence Address: MCANDREWS HELD & MALLOY, LTD, 500 WEST MADISON STREET, SUITE 3400, CHICAGO, IL, 60661, US

(21) Appl. No.: 11/317,578

(22) Filed: Dec. 23, 2005

(51) Int. Cl. H04N 11/04; H04N 7/12

(52) U.S. Cl. 375/240.03; 375/240.12

(57) ABSTRACT

Presented herein are system(s), and method(s) for inverse quantizing data from a plurality of standards. In one embodiment, there is presented a system for decoding data. The system comprises a host processor and an inverse quantizer. The host processor provides inverse quantization parameters from a first standard and from a second standard that are transcoded to a particular format. The inverse quantizer receives the transcoded quantization parameters in the particular format and inverse quantizes quantized data quantized in accordance with the first standard and the second standard based on the transcoded quantization parameters.

### CLAIM OF PRIORITY

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

There are a number of different standards that are available for compressing video data. These standards include standards promulgated by the Motion Picture Experts Group (MPEG). The standards promulgated by MPEG include MPEG1, MPEG-2, and MPEG-4, Part 10 (also known as Advanced Video Coding and also known and now referred to as H.264).

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Presented herein are system(s) and method(s) for programmable controls for inverse quantizing with a plurality of standards, substantially as shown in and/or described in connection with at least one of the figures, as set forth more completely in the claims.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary circuit in accordance with an embodiment of the present invention;

FIG. 1B is a flow diagram for decoding data in accordance with an embodiment of the present invention;

FIG. 2 is a block diagram describing video data;

FIG. 3 is a block diagram describing a video decoder for the MPEG-2 encoding standard in accordance with an embodiment of the present invention;

FIG. 4 is a block diagram of an exemplary inverse quantizer in accordance with an embodiment of the present invention; and

FIG. 5 is a block diagram of the control unit describing the concept of common control command decode in accordance with an embodiment of the present invention.

### DETAILED DESCRIPTION OF THE INVENTION

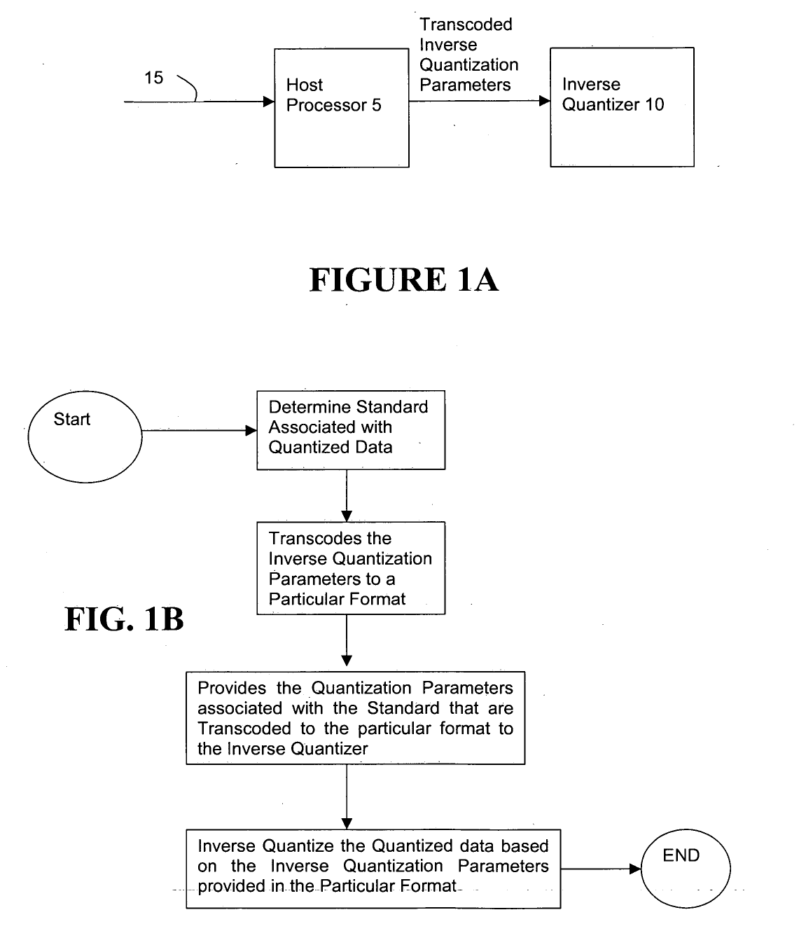

Referring now to FIG. 1A, there is illustrated a block diagram of an exemplary circuit in accordance with an embodiment of the present invention. The circuit 1 comprises a host processor 5 and an inverse quantizer 10.

The circuit receives quantized data 15 for decoding. The quantized data can be quantized in accordance with any one of a number of different standards. For example, there are a number of data compression standards for video data that are used to compress the video data. The foregoing standards can have a variety of quantization techniques.

The foregoing standards specify the technique for quantizing and inverse quantizing that are utilized for quantizing and inverse quantizing the data with the use of parameters. Inverse quantization parameters specify the technique for inverse quantizing the quantized data. The inverse quantization, parameters are usually inserted at separate and distinct locations from the quantized data. For example, the quantized data can be received in packets. The packets can include header information and a payload. The payload can carry the quantization data while the header can carry the inverse quantization parameters that specify the inverse quantization technique used for inverse quantizing the quantized data.

The host processor 5 receives the inverse quantization parameters and provides quantization parameters that are transcoded to a particular format. In certain embodiments of the present invention, the host processor 5 transcodes the inverse quantization parameters to the particular format.

in certain embodiments, the host processor 5, or other circuitry can parse the headers of packets to determine the standard and retrieve the inverse quantization parameters for the quantized data in the packet.

The inverse quantizer 10 receives the transcoded inverse quantization parameters and uses the inverse quantization parameters to inverse quantize the quantized data 15. The inverse quantization parameters can specify the manner in which the inverse quantizer 10 inverse quantizes the quantized data.

In certain embodiments, the host processor 5 can be programmed to transcode inverse quantization parameters from a variety of different standards, such as MPEG-2, H.264, and VC-1, to a common format that can unambiguously provide any of the possible inverse quantization parameters from the different standards to the inverse quantizer 10. The common format can be internal to the circuit 1 and proprietary.

In certain embodiments of the present invention, a pre-existing host processor 5 that can transcode the inverse quantization parameters to the particular format can be programmed to transcode additional standards to the particular format.

Referring now to FIG. 1B, there is illustrated a flow diagram for inverse quantizing data, in accordance with an embodiment of the present invention. At 25, the host processor 5 determines a standard associated with received quantized data.

In certain embodiments of the present invention, the host processor 5 can determine the standard associated with the received quantized data by examining headers of packets that comprise the quantized data and determining the standards associated with the quantized data based on parsing of the header.

At 30, the host processor 5 transcodes the inverse quantization parameters to a particular format. The host processor 5 provides the quantization parameters associated with the standard that is transcoded to the particular format to the inverse quantizer 10 at 35. At 40, the inverse quantizer inverse quantizes the quantized data based on the inverse quantization parameters provided in the particular format.

After 40, the foregoing, 25-40 can be repeated. In certain embodiments, different standards can be encountered during 25 during successive iterations of 25 -0.

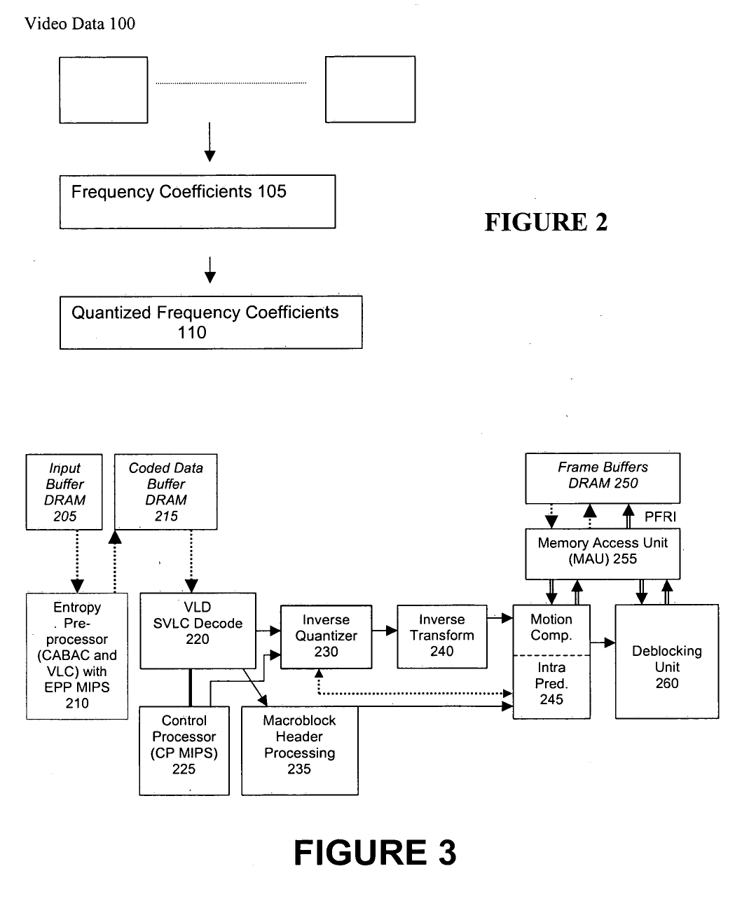

Referring now to FIG. 2, there is illustrated a block diagram describing the encoding of video data. Video data comprises a series of pictures 100. The video data is compressed using a variety of techniques that take advantage of both temporal and spatial redundancies. Pixel-to-frequency transformations are applied to take advantage of spatial redundancies. The transformation results in a set of frequency coefficients 105. The frequency coefficients 105 are then quantized 110. The quantization further compresses the video data by controlling the numbers of bits that are used to quantize the frequency coefficients. Additional compression techniques are then used to further compress the video data.

The quantization techniques used depend on the encoding standard. The encoding standards include standards promulgated by the Motion Picture Experts Group (MPEG) and those promulgated by the Society of Motion Pictures and Television Engineers (SMPTE) and Microsoft Corporation. The standards promulgated by MPEG include MPEG1, MPEG-2 and MPEG-4, Part 10 (also known as Advanced Video Coding and also known and now referred to as H.264). VC-1 is a standard promulgated by the SMPTE, and by Microsoft Corporation (as Windows Media 9 or WM9).

Referring now to FIG. 3, there is illustrated a block diagram describing an exemplary video decoder 200 in accordance with an embodiment of the present invention. The video decoder 200 comprises an entropy pre-processor 205, a coded data buffer 210, a variable length decoder 215, a control processor 225, an inverse quantizer 230, a macroblock header processor 235, an inverse transformer 240, a motion compensator 245, a deblocker 250, a memory access unit 255, and frame buffers 260.

The entropy pre-processor 205 receives encoded video data. The encoded video data can comprise entropy coded symbols. The entropy pre-processor 205 decodes the entropy coded symbols. The entropy pre-processor 205 writes the symbols to the coded data buffer 210. The variable length decoder 215 decodes variable length codes in the encoded video data.

The foregoing results in quantized frequency coefficients 110 and macroblock headers.

The inverse quantizer 230 inverse quantizes the quantized frequency coefficients 110, resulting in frequency coefficients 105. The inverse transformer 240 inverse transforms the frequency coefficients 105, resulting in pixel data. The motion compensator 240 motion compensates the pixel data, using previously decoded pictures 100 stored in the frame buffers 260.

The quantization techniques used depend on the encoding standard. As mentioned above, the encoding standards include standards promulgated by the Motion Picture Experts Group (MPEG) and that by the Society of Motion Pictures and Television Engineers (SMPTE) and Microsoft Corporation. Again, the standards promulgated by MPEG include MPEG1, MPEG-2 and MPEG-4, Part 10 (also known as Advanced Video Coding and also known and now referred to as H.264). VC-1 is a standard promulgated by the SMPTE, and by Microsoft Corporation (as Windows Media 9 or WM9).

Accordingly, the control processor 225 receives the quantized data in the form of data packets, determines the standard used for the quantized data, and provides transcoded inverse quantization parameters in a particular format to the inverse quantizer 230.

In certain embodiments, the particular format can unambiguously express any of the inverse quantization parameters in MPEG1, MPEG-2, H.264, and VC-1. The inverse quantizer 230 inverse quantizes the quantized data based on the transcoded inverse quantization parameters received from the control processor 225.

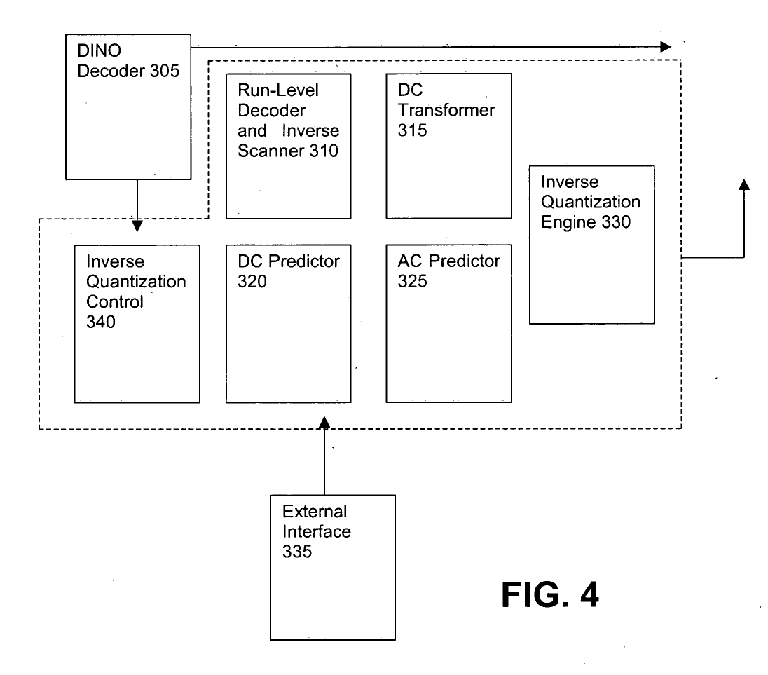

Referring now to FIG. 4, there is illustrated a block diagram describing an exemplary inverse quantizer 230 in accordance with an embodiment of the present invention. The inverse quantizer 230 comprises a run level decoder and inverse scanner 310, a DC transformer 315, a DC predictor 320, an AC predictor 325, an inverse quantization engine 330, external interfaces 335 and inverse quantizer Control unit 340.

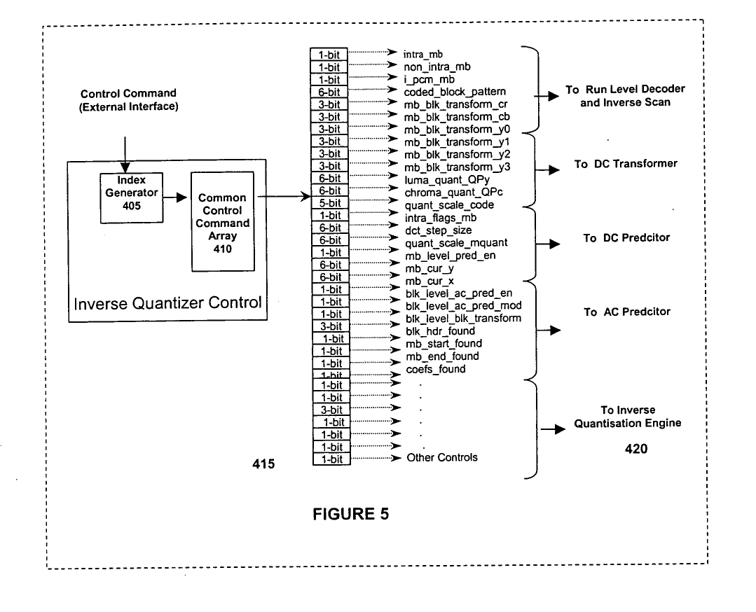

Referring now to FIG. 5, there is illustrated a block diagram describing an exemplary inverse quantizer control 340 in accordance with an embodiment of the present invention. The inverse quantizer control 340 comprises a command and index generator 405 which interprets and decodes the control commands and generates the index to the common control command array 410. The common control command array has the pre-determined/pre-loaded control flags 415 which are used for enabling or disabling the data path activity in blocks 420 such as Run-level-Decoder, DC predictor, AC Predictor, DC Transform, Inverse quantizer.

Run-Level Decoder/DC Prediction/Inverse Scan

The run level decoder/inverse scanner 320 and DC predictor 320 can be clubbed in a single data path if their operations are sequentially dependent. The run level decoder/inverse scanner 310 does the “zero” filling operation, decided by the run count of the current run-level pair. DC predictor 320 performs DC prediction if DC prediction is enabled for the current block. This is present in intra blocks of VC-1. This is done by choosing the prediction direction, which is based on the relative DC values of the neighboring left, top and diagonal blocks. The inverse scan operation is accomplished by providing a correct address of a buffer based on a lookup table value. These lookup table values are programmed during the picture level initialization.

AC Prediction:

The AC predictor 325 performs AC prediction if AC prediction is enabled for the current block under decode. AC prediction is present in the VC-1 video standard. The DC-Predictor 320 supplies the prediction direction and the prediction data will be from either top row or the left column. The prediction coefficients are written to a DRAM.

DC Transform:

The DC transformer 315 performs matrix multiplication of the DC-only luma and chroma sub-blocks of AVC with the constant matrix. The constant matrix has signed unit coefficients. Based on this fact, matrix multiplication is performed by add-accumulate operation. There are two passes in the DC transform for two sets of matrix multiplication.

Inverse Quantization:

The inverse quantization engine 330 supports inverse quantization for a plurality of video encoding standards. In certain embodiments of the present invention, there may be seven types of inverse quantization present based on the block-type (video standard under decode), where MPEG2 has two types, AVC has three types and VC-1 has two types. The type of the Inverse quantization depends on the macro-block type and Luma-chroma blocks (sub-blocks).

The inverse quantization engine 330 inverse quantizes the quantized data based on inverse quantization parameters that are transcoded to a particular format. The external interface 335 receives the transcoded inverse quantization parameters from the control processor 225. The inverse quantization engine 330 inverse quantizes the quantized data based on the transcoded inverse quantization parameters.

The inverse control block 340 decodes the transcoded internal format and generates the control signals. The control signals generated are common to the video standards, but the actions stimulated by the control signals may be unique to a particular video standard being inverse quantized.

The embodiments described herein may be implemented as a board level product, as a single chip, application specific integrated circuit (ASIC), as part of an ASIC containing other functions, or with varying levels of the decoder system integrated with other portions of the system as separate components.

The degree of integration of the decoder system will primarily be determined by the speed and cost considerations. Because of the sophisticated nature of modern processor, it is possible to utilize a commercially available processor, which may be implemented external to an ASIC implementation. If the processor is available as an ASIC core or logic block, then the commercially available processor can be implemented as part of an ASIC device wherein certain functions can be implemented as sets of instructions, such as firmware. Alternatively, the functions can be implemented as hardware accelerator units controlled by the processor. In certain embodiments, the circuit described herein can be incorporated into an integrated circuit.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings' of the present invention without departing from its scope.

Therefore, it is intended that the present invention not be limited to the particular embodiment disclosed, but that the present invention will include all embodiments falling within the scope of the appended claims.

What is claimed is:

1. A system for decoding video data, said system comprising:
a host processor for providing inverse quantization parameters from a first standard and from a second standard that are transcoded to a particular format; and
an inverse quantizer for receiving the transcoded quantization parameters in the particular format and inverse quantizing data quantized in accordance with the first standard and the second standard based on the transcoded quantization parameters.

2. The system of claim 1, wherein the first encoding standard is MPEG-2 and the second encoding standard is H.264.

3. The system of claim 1, wherein the processor transcodes parameters from a third standard to the particular format.

4. The system of claim 3, wherein the first standard is MPEG-2, the second standard is H.264, and the third standard is VC-1.

5. The system of claim 3, further comprising:
a transformer for inverse transforming the inverse quantized data.

6. The system of claim 1, wherein the host processor transcodes the quantization parameters from the first standard and from the second standard.

7. The system of claim 1, wherein the host processor determines a standard associated with the quantized data.

8. A method for inverse quantizing data, said method comprising:
determining a standard associated with the inverse quantized data;
providing quantization parameters associated with the standard that are transcoded to a particular format; and
inverse quantizing the quantization parameters based on the particular format.

9. The method of claim 8, further comprising:
transcoding the parameters associated with the standard to the particular format.

10. The method of claim 8, wherein the standard associated with the inverse quantized data may be any standard selected from a group consisting of MPEG-2, VC-1, and H.264.

11. The method of claim 8, wherein determining the standards associated with the quantized data further comprises:
examining headers of packets comprising the quantized data; and
determining the standards associated with the quantized data based on examination of the headers.

12. The method of claim 8, further comprisinging:
determining another standard associated with other quantized data;
providing quantization parameters associated with the another standard that are transcoded to the particular format; and
inverse quantizing the other quantization parameters based on the particular format.

13. The method of claim 12, wherein the standard is MPEG-2 and the other standard is AVC.

14. The method of claim 12, wherein the standard is MPEG-2 and the other standard is VC-1.

15. The method of claim 12, wherein the standard is AVC and the other standard is VC-1.
